(19) United States
(12) Patent Application Publication
(10) Pub. No.: US 2015/0205036 A1
(43) Pub. Date: Jul. 23, 2015

(54) LIGHTING DEVICE, DISPLAY DEVICE AND TELEVISION DEVICE

(71) Applicant: Sharp Kabushiki Kaisha, Osaka-shi, Osaka (JP)

(72) Inventor: Takaharu Shimizu, Osaka-shi (JP)

(21) Appl. No.: 14/416,291

(22) PCT Filed: Jul. 30, 2013
(86) PCT No.: PCT/JP2013/070576

§ 371 Date: Jan. 22, 2015

(30) Foreign Application Priority Data
Aug. 3, 2012 (JP) 2012-172780

(51) Int. Cl. F21V 8/00

(52) U.S. Cl. CPC G02B 6/0086; G02B 6/0073; G02B 6/0088

(57) ABSTRACT

A backlight unit 24 includes a light guide plate 20, a first LED 28, a second LED 29, and a frame 14. The light guide plate 20 includes two end surfaces configured as light entrance surfaces 20a1 and 20a2, a light exit surface 20b on the front side, and an opposite surface 20c on the rear side. The first LED 28 is opposite the first light entrance surface 20a1. The second LED 29 is arranged opposite the second light entrance surface 20a2 such that a distance between the second LED 29 and the second light entrance surface 20a1 is larger than a distance between the first LED 28 and the first light entrance surface 20a1. The frame 14 is a frame-shaped member that covers the first LED 28 and a portion of the light exit surface 20b. The frame 14 includes a projection 15 that projects from a portion of the frame 14 exposed to the first LED 28 farther toward the opposite surface 20c than the light exit surface 20b. A portion of the projection 15 is located closer to the first light entrance surface 20a1 than a main light emitting surface of the first LED 28.

### TECHNICAL FIELD

The present invention relates to a lighting device, a display device, and a television device.

### BACKGROUND ART

Display components in image display devices, such as television devices, are now being shifted from conventional cathode-ray tube displays to thin display panels, such as liquid crystal panels and plasma display panels. With the thin display panels, the thicknesses of the image display devices can be reduced. Liquid crystal panels included in the liquid crystal display devices do not emit light, and thus backlight devices are required as separate lighting devices. The backlight devices are generally classified into direct-type and edge-light-type according to mechanisms. To further reduce the thicknesses of the liquid crystal display devices, the edge-light-type backlight devices are more preferable. An example of such a device is disclosed in Patent Document 1.

### RELATED ART DOCUMENT

### Patent Document

Patent Document 1: Japanese Unexamined Patent Application Publication No. 2011-216270

### Problem to be Solved by the Invention

In an edge-light-type backlight device, efficiency of incidence increases as a distance between a light source and a light entrance surface of a light guide plate decreases, and the efficiency of incidence decreases as the distance increases. The light guide plate thermally expands due to heat from the light source produced while the light source is turned on. Therefore, the light source and the light entrance surface of the light guide plate need to be separated from each other by a sufficient distance so that the light guide plate that extends due to the thermal expansion does not contact the light source. There is limitation to improve the efficiency of incidence from the light source to the light entrance surface of the light guide plate.

### Disclosure of the Present Invention

The technology described in this specification was made in view of the foregoing circumstances. An object is to improve light use efficiency by keeping an end surface of a light guide plate from contacting a light source.

### Means for Solving the Problem

Technologies described herein are related to a lighting device having the following configurations. The lighting device includes a light guide plate, a first light source, a second light source, and a frame-shaped member. The light guide plate includes two end surfaces and plate surfaces. The end surfaces are configured as light entrance surfaces. One of the plate surfaces is configured as a light exit surface. Another one of the plate surfaces are configured as an opposite surface. The first light source includes a main light emitting surface arranged opposite the first end surface of the light guide plate configured as the first light entrance surface. The second light source includes a main light emitting surface arranged opposite the second end surface of the light guide plate opposite from the first end surface and configured as the second light entrance surface. The second light soured is arranged such that a distance between the second light source and the second light entrance surface is larger than a distance between the first light source and the first light entrance surface. The frame-shaped member has a frame-like shape and arranged over a side surface of the first light source closer to the light emit surface and an edge portion of the light exit surface so as to cover the first light source and the edge portion of the light exit surface. The frame-shaped member includes a projection that projects from a portion of the frame-shaped member exposed to the first light source farther toward the opposite surface than the light exit surface. The projection includes a portion arranged closer to the first light entrance surface than the main light emitting surface of the first light source.

In the above lighting device, the light emitted by the first light source enters the first light entrance surface and the light emitted by the second light source enters the second light entrance surface. Then, the light travels within the light guide plate and exits through the light exit surface. The distance between the first light source and the first light entrance surface of the light guide plate is relatively small and the distance between the second light source and the second light entrance surface of the light guide plate is relatively large. Therefore, the efficiency of incidence from the first light source to the first light entrance surface is relatively high and the efficiency of incidence from the second light source to the second light entrance surface is relatively low. According to the inventor's studies, a rate of decrease in efficiency of incidence due to an increase in distance between each light source and the corresponding light entrance surface decreases as the distance becomes equal to or larger than a certain distance and becomes constant. Therefore, the efficiency of incidence from the second light source to the second light entrance surface becomes lower than the efficiency of incidence from the first light source to the first light entrance surface. However, the efficiency of incidence from the second light source to the second light entrance surface does not decrease further than a certain level because the rate of decrease in efficiency of incidence due to the increase in distance decreases. When efficiency of incidence under a condition that the distance between one of the light sources and the corresponding light entrance surface is set equal to the distance between the other light source and the corresponding light entrance surface is set as a reference, a differential of the efficiency of incidence from the first light source to the first light entrance surface above the reference is larger than a differential of the efficiency of incidence from the second light source to the second light entrance surface under the reference. According to the configuration described earlier, overall light use efficiency is improved in comparison to the configuration in which the distance between one of the light sources and the corresponding light entrance surface is set equal to the distance between the other light source and the corresponding light entrance surface.

According to the lighting device described above, the frame-shaped member includes the projection having the configuration described above. When the first light entrance surface of the light guide plate moves toward the first light source due to thermal expansion, the first light entrance surface contacts the projection before contacting the first light source. With this configuration, further movement of the first light entrance surface toward the first light source is restricted and thus the first light entrance surface does not collide with the first light source, that is, the end surface of the light guide plate does not contact the light source. Therefore, the first light source can be arranged adjacent to the first light entrance surface. With the configuration that improves the overall efficiency of using the light from the first light source and the configuration in which the first light source is arranged to the first light entrance surface, the efficiency of using light from the first light source can be significantly improved in comparison to the configuration in which the distance between one of the light sources and the corresponding light entrance surface is set equal to the distance between the other light source and the corresponding light entrance surface. As described above, according to the lighting device described above, the end surface of the light guide plate does not contact the light source during the thermal expansion of the light guide plate. Therefore, the light use efficiency can be significantly improved.

The light guide plate may include a recess that is open at least on a light exit surface side. At least a portion of the projection may be arranged in the recess. A distance between the projection and a wall of the recess facing toward the first light source may be smaller than a distance between the first light source and the first light entrance surface.

A width of the projection measuring in a direction perpendicular to the first light entrance surface needs to be larger than a certain size to maintain the strength thereof. If the distance between each first light source and the first light entrance surface is very small, the width of the projection needs to be small. As a result, the strength of the projection is not maintained. Because of the recess in the light guide plate, the portion of the projection is arranged closer to a middle portion of the light guide plate than the first light entrance surface of the light guide plate. Therefore, the width of the projection is larger than the distance between the first light source and the light guide plate. In the above configuration, when the light guide plate is thermally expanded, the first light entrance surface moves toward the first light source and the wall of the recess moves toward the first light source. The distance between the projection and the wall of the recess is smaller than the distance between the first light source and the first light entrance surface. Therefore, the wall of the recess contacts the projection before the first light entrance surface contacts the first light source. According to this configuration, the distance between the first light source and the first light entrance surface can be reduced while the strength of the projection is maintained.

The recess may be formed at an edge of the light exit surface and open on a first light entrance surface side.

According to this configuration, the recess is open on the first light entrance surface side and thus at least a portion of the projection can be easily placed in the recess in the production process of the lighting device.

The recess may continuously extend along the edge of the light exit surface.

According to this configuration, an entire edge of the light exit surface is in contact with the projection during the thermal expansion of the light guide plate. Therefore, the contact of the first light entrance surface with the light source is effectively restricted.

The side surface of the first light source closer to the light exit surface may be arranged closer to the opposite surface than a distal end of the projection on an opposite surface side.

Because the side surface of the first light source closer to the light exit surface is arranged closer to the opposite surface than the distal end of the projection on the opposite surface side, a portion of the projection is arranged between the main light emitting surface of the first light source and the first light entrance surface. Some rays of light emitted by the first light source are blocked by the projection and thus the efficiency of incidence to the first light entrance surface decreases. According to the configuration described above, the rays of light emitted by the first light source are less likely to be blocked. Therefore, a proper level of the efficiency of incidence to the first light entrance surface is achieved.

The projection may include an opposed surface that is in surface contact with the first light entrance surface during thermal expansion of the light guide plate.

According to this configuration, because the first light entrance surface of the light guide plate is in surface contact with the projection, the thermal expansion of the light guide plate is restricted. Namely, the expansion of the light guide plate is effectively restricted.

A distance between the second light source and the second light entrance surface may be larger than a maximum distance for which the second light entrance surface moves during thermal expansion of the light guide plate.

The lighting device may further include a positioning portion for positioning the light guide plate relative to the first light source and the second light source with respect to a direction perpendicular to the first light entrance surface such that a distance between the second light source and the second light entrance surface is larger than a distance between the first light source and the first light entrance surface.

According to this configuration, the light guide plate extends with the positioning recess as a base point of the extension due to the thermal expansion. A variation in position of the light entrance surface of the light guide plate due to the extension thereof tend to be proportional to the distance between the positioning recess and the corresponding light entrance surface. By setting the distance between the positioning recess and the second light entrance surface of the light guide plate larger than the distance between the positioning recess and the first light entrance surface of the light guide plate, the variation in position of the second light entrance surface due to the thermal expansion of the light guide plate is larger than the variation in position of the first light entrance surface. With the distance between the second light source and the second light entrance surface, which is relatively large, the extension of the light guide plate is allowed. According to this configuration, a sum of the distance between each light source and the corresponding light entrance surface can be reduced as much as possible. Therefore, the size of the lighting device (or a frame side) can be reduced.

The lighting device may further include a reflection sheet having light reflectivity and arranged on the opposite surface of the light guide plate. The reflection sheet may extend such that an edge of the reflection sheet on a first light entrance surface side is closer to the first light source than the first light entrance surface and an edge of the reflection sheet on a second light entrance surface side is closer to the second light source than the second light entrance surface.

According to this configuration, rays of light emitted by the first light source traveling toward the opposite surface are reflected toward the first light entrance surface by an extended portion of the reflection sheet which extends toward the first light source farther than the first light entrance surface. Rays of light emitted by the second light source traveling toward the opposite surface are reflected toward the second light entrance surface by an extended portion of the reflection sheet which extends toward the second light source farther than the second light entrance surface. With this configuration, the efficiency of incidence to the first light entrance surface and the efficiency of incidence to the second light entrance surface can be further improved.

The technologies described in this specification may be applied to a display device including a display panel configured to provide display using light from the above-described lighting device. A display device that includes a liquid crystal panel as such a display panel may be considered as new and advantageous. Furthermore, a television device including the above-described display device may be considered as new and advantageous.

### Advantageous Effect of the Invention

According to the technologies described in this specification, the contact of the end surface of the light guide plate with the light source is restricted and thus the light use efficiency is improved.

### BRIEF DESCRIPTION OF THE DRAWINGS

FIG. 1 is an exploded perspective view illustrating a general configuration of a television device TV according to a first embodiment of the invention.

FIG. 2 is an exploded perspective view of the liquid crystal display device 10 illustrating a general configuration of the liquid crystal display device 10.

FIG. 3 is a cross-sectional view of the liquid crystal display device 10 along a short-side direction thereof illustrating a cross-sectional configuration.

FIG. 4 is a magnified cross-sectional view of a relevant portion of the liquid crystal display device 10 in FIG. 3 illustrating a projection 15 and therearound.

FIG. 5 is a plan view of a backlight unit 24.

FIG. 6 is a cross-sectional view of a relevant portion of a liquid crystal display device 110 according to a second embodiment.

FIG. 7 is a plan view of a back light unit 124.

FIG. 8 is a plan view of a backlight unit 224 according to a modification of the second embodiment.

FIG. 11 is a cross-sectional view of a relevant portion of a liquid crystal display device 210 according to a third embodiment.

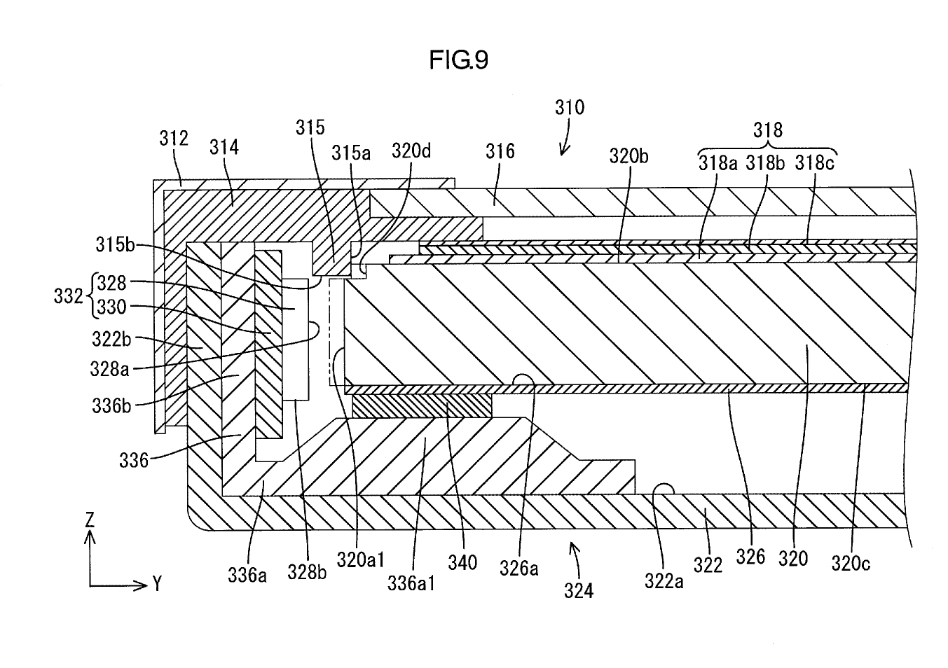

FIG. 15 is a cross-sectional view of a liquid crystal display device 410 according to a fifth embodiment.

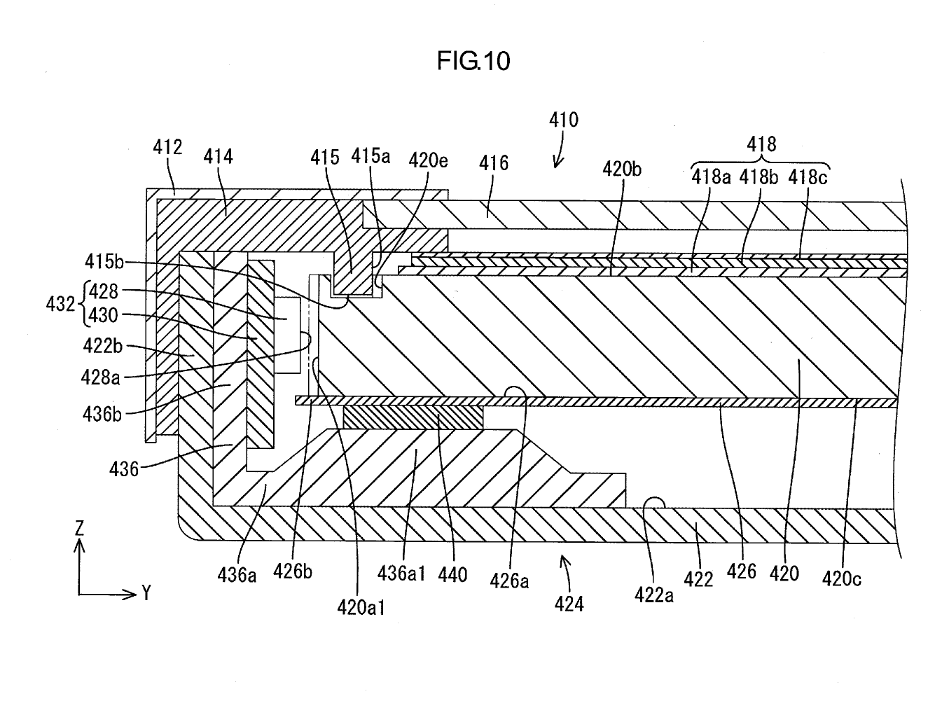

### MODE FOR CARRYING OUT THE INVENTION

### First Embodiment

A first embodiment will be described with reference to the drawings. In the following description, a liquid crystal display device 10 will be described. X-axes, Y-axes and Z-axes are provided in portions of the drawings, respectively. The axes in each drawing correspond to the respective axes in other drawings. The X-axes and Y-axes are aligned with the horizontal direction and the vertical direction, respectively. In the following description, the top-bottom direction corresponds to the vertical direction unless otherwise specified.

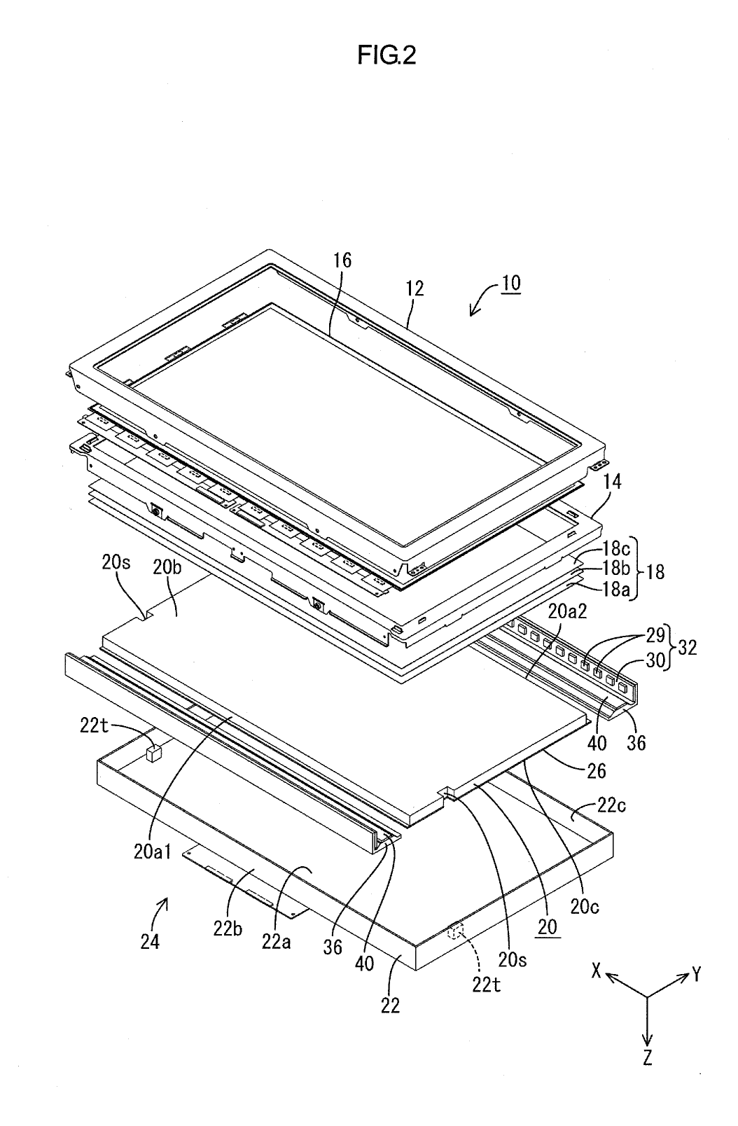

A television device TV includes the liquid crystal display device (an example of a display device) 10, front and rear cabinets Ca, Cb that hold the liquid crystal display device 10 therebetween, a power source P, a tuner T, and a stand S. In FIG. 2, the upper side and the lower side correspond to the front side and the rear side of the liquid crystal display device 10, respectively. As illustrated in FIG. 2, an overall shape of the liquid crystal display device 10 is a horizontally-long rectangular. The liquid crystal display device 10 includes a liquid crystal panel 16 and a backlight unit (an example of a lighting device) 24. The liquid crystal panel 16 is a display panel and the backlight unit 24 is an external light source. The liquid crystal panel 16 and the backlight unit 24 are integrally held with a bezel 12 having a frame-like shape.

As illustrated in FIG. 2, components of the liquid crystal display device 10 are arranged in a space provided between the bezel 12 that forms a front external appearance and a chassis 22 that forms a rear external appearance. The components arranged between the bezel 12 and the chassis 22 include at least the liquid crystal panel 16, a frame 14, an optical member 18, a light guide plate 20, LED units 32, and heat dissipation members 36. The frame 14 is a frame-shaped member arranged over side surfaces of first LEDs 28 and second LEDs 29 on a light exit surface 20b side and edge portions of the light exit surface 20b so as to cover the first LEDs 28 and portions of the light exit surface 20b. The frame 14 holds the liquid crystal panel 16 at inner edge portions of the frame 14. The liquid crystal panel 16 and the optical member 18 are separated from each other with the inner edge portions of the frame 14 arranged therebetween. The optical member 18 is placed on the light guide plate 20. The backlight unit 24 includes the optical member 18, the light guide plate 20, the LED units 32, the heat dissipation member 36, and the chassis 22. Namely, the configuration of the liquid crystal display device 10 without the bezel 12, the liquid crystal panel 16 and the frame 14 corresponds to the backlight unit 24. The LED units 32 and the heat dissipation members 36, 36 included in the backlight unit 24 are arranged in the chassis 22 such that the heat dissipation members 36, 36 are opposed to long end surfaces of the light guide plate 20, respectively. Each component will be described next.

The liquid crystal panel 16 includes a pair of transparent glass substrates (having a high light transmission capability) and a liquid crystal layer (not illustrated). The glass substrates are bonded together with a predetermined gap therebetween. The liquid crystal layer is sealed between the glass substrates. On one of the glass substrates, switching components (e.g., TFTs) connected to source lines and gate lines that are perpendicular to each other, pixel electrodes connected to the switching components, and an alignment film are provided. On the other substrate, a color filter having color sections including R (red), G (green) and B (blue) color sections arranged in a predetermined pattern, counter electrodes and an alignment film are provided. Image data and various control signals are transmitted from a driver circuit board (not illustrated) to the source lines, the gate lines, and the counter electrodes for displaying images. Polarizing plates (not illustrated) are attached to outer surfaces of the glass substrates.

As illustrated in FIG. 2, similar to the liquid crystal panel 16, the optical member 18 has a horizontally-long rectangular shape in a plan view and has the same size (i.e., a short-side dimension and a long-side dimension) as the liquid crystal panel 16. The optical member 18 is placed on a front surface of the light guide plate 20 (i.e., the light exit surface 20b). The optical member 18 includes three sheets that are placed on top of one another. Specifically, a diffuser sheet 18a, a lens sheet (a prism sheet) 18b, and a reflecting type polarizing sheet 18c are placed on top of one another in this sequence from the rear side (the light guide plate 20 side). Each of the three sheets 18a, 18b, and 18c has the substantially same size in a plan view.

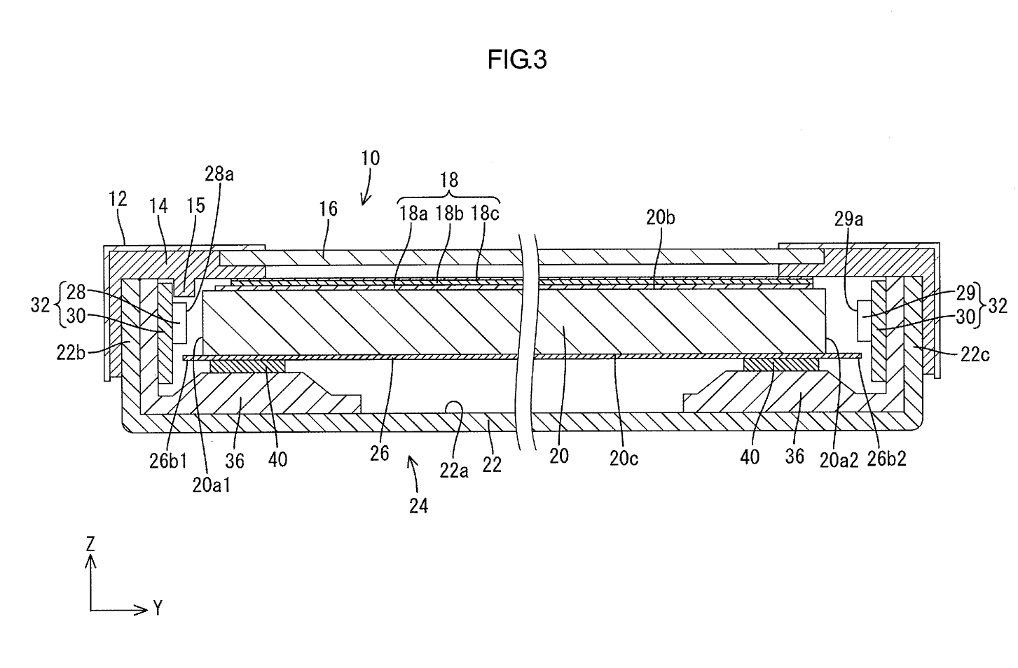

The light guide plate 20 is made of substantially transparent (high light transmissivity) synthetic resin (e.g. acrylic resin or polycarbonate such as PMMA) which has a refractive index sufficiently higher than that of the air. As illustrated in FIG. 2, the light guide plate 20 has a horizontally-long rectangular shape in a plan view similar to the liquid crystal panel 16 and the optical member 18. A thickness of the light guide plate 20 is larger than a thickness of the optical member 18. A long-side direction and a short-side direction of a main surface of the light guide plate 20 correspond to the X-axis direction and the Y-axis direction, respectively. A thickness direction of the light guide plate 20 that is perpendicular to the main surface of the light guide plate 20 corresponds to the Z-axis direction. The light guide plate 20 is arranged on the rear side of the optical member 18 and away from a bottom plate 22a of the chassis 22, which will be described later. As illustrated in FIG. 3, at least a short-side dimension of the light guide plate 20 is the same as short-side dimensions of the liquid crystal panel 16 and the optical member 18.

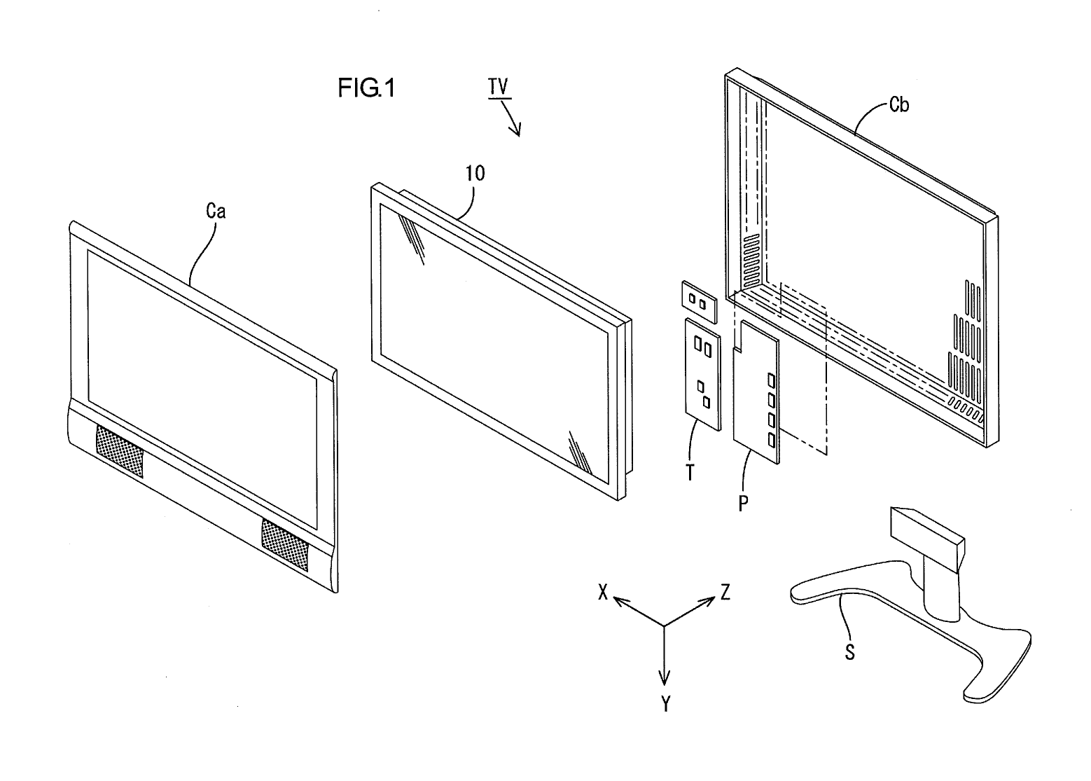

The light guide plate 20 includes light entrance surfaces 20a1 and 20a2 on short sides thereof, respectively. One of the light entrance surfaces is a first light entrance surface 20a1. The first light entrance surface 20a1 is a surface located on the lower side when the liquid crystal display device 10 is set in a vertical position for using as a television device (i.e., the light entrance surface that faces a sidewall 22b of the chassis 22) (see FIG. 1). The other light entrance surface is a second light entrance surface 20a2 that is on the upper side (i.e., the light entrance surface that faces the other sidewall 22c of the chassis 22). The LED units 32 are arranged on sides of the short dimension of the light guide plate 20 so as to have the light guide plate 20 between the LED units 32 in the Y-axis direction. Rays of light from the LEDs 28 and 29 enter the light guide plate 20 through the respective light entrance surfaces 20a1 and 20a2. The light guide plate 20 is configured to guide the rays of light, which are from the LEDs 28 and enter the light guide plate 20 through ends of the short dimension thereof, toward the optical member 18 (on the front side). In the backlight unit 24 according to this embodiment, the LED unit 32, behind which the light guide plate 20 and the optical member 18 are arranged and which are a light source, are arranged at the side edges of the light guide plate 20. Namely, an edge lighting method (a side lighting method) is adapted to the backlight unit 24.

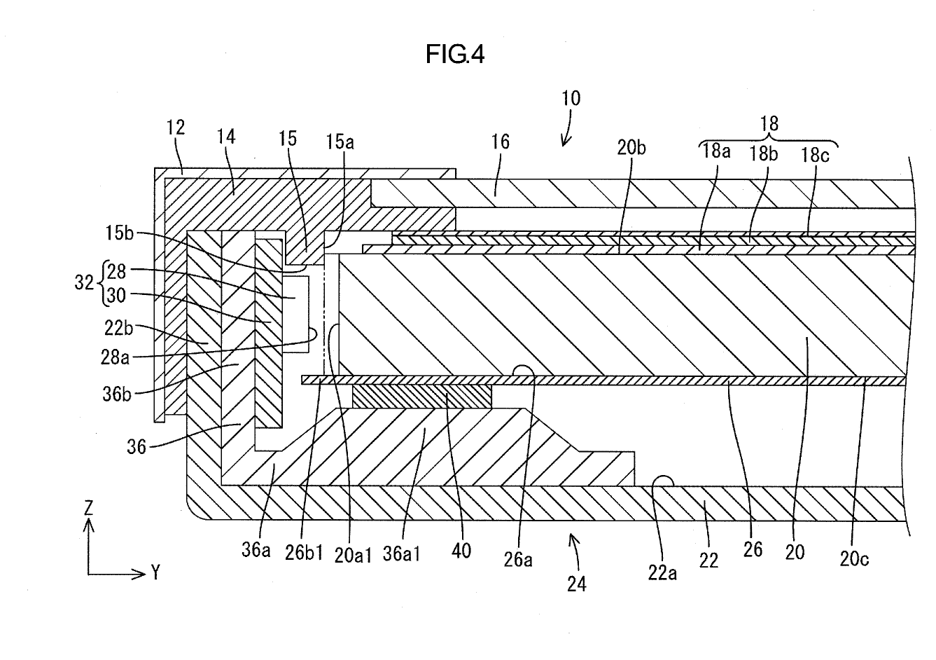

One of main surfaces of the light guide plate 20 facing the front side (a surface opposite the optical member 18) is the light exit surface 20b. Light exits the light guide plate 20 through the light exit surface 20b toward the optical member 18 and the liquid crystal panel 16. The light guide plate 20 includes end surfaces that are adjacent to the main surfaces of the light guide plate 20. Two of the end surfaces on the long sides (i.e., end surfaces of the short dimension) which have elongated shapes along the X-axis direction are opposite the LEDs 28. The end surfaces on the long sides are the light entrance surfaces 20a. As illustrated in FIG. 4, a reflection sheet 20 is arranged on the rear side of the light guide plate 20, which is, on an opposite surface 20c that is opposite from the light exit surface 20b (a surface opposite the chassis 22). The reflection sheet 20 is arranged to cover an entire area of the opposite surface 20c.

The light guide plate 20 includes positioning recesses 20s (an example of a positioning portion) formed in end surfaces on short sides thereof. Each positioning recess 20s has a rectangular shape in a plan view and opens to the corresponding sidewall of the chassis 22, which will be described later. The positioning recess 20s is located closer to the first light entrance surface 20a1 than the second light entrance surface 20a2. Namely, a distance between the positioning recess 20s and the second light entrance surface 20a2 is relatively larger than a distance between the positioning recess 20s and the first light entrance surface 20a1. When positioning projections 22t, which will be described later, are fitted in the positioning recesses 20s, the light guide plate 20 is positioned in the plate direction (an X-Y plane direction) with respect to the chassis 22.

As illustrated in FIG. 2, the chassis 22 has a horizontally rectangular box-like overall shape so as to about entirely cover the light guide plate 20, the LED units 32, and the heat dissipation members 36 from the rear side. The chassis 22 is made of metal, for instance, aluminum-based material. The chassis 22 includes a bottom plate 22a, sidewalls 22b, 22b that upstand from the respective long edges of the bottom plate 22a, and sidewalls that upstand from the respective short edges of the bottom plate 22a. In the chassis 22, space between the LED units 32 is a holding space for the light guide plate 20. A power supply circuit board for supplying power to the LED unit 32 is mounted to the back surface of the bottom plate 22a (not illustrated).

The reflection sheet 26 is in contact with the opposite surface 20c of the light guide plate 20. Between the reflection sheet 26 and the bottom plate 22a of the chassis 22, the heat dissipation member 36 is arranged so that the reflection sheet 26 is spaced from the bottom plate 22a of the chassis 22. The reflection sheet 26 is made of synthetic resin and has a white surface that has high light reflectivity. In this configuration, light that exits the light guide plate 20 through the opposite surface 20c toward the rear side is reflected by the reflection sheet 26 toward the front side. A long dimension of the reflection sheet 26 is substantially the same as a long dimension of the light guide plate 20.

As illustrated in FIG. 4, the reflection sheet 26 includes a first extending portion 26b1 at an end thereof closer to the first LEDs 28. The first extending portion 26b1 extends over the first light entrance surface 20a1 toward the first LEDs 28. The first extending portion 26b1 extends to a position that overlaps the first LEDs 28 in a plan view, that is, extends to a position under the first LEDs 28. The reflection sheet 26 includes a first extending portion 26b2 at an end of the reflection sheet 26 closer to the second LEDs 29. The second extending portion 26b2 extends over the second light entrance surface 20a2 of the light guide plate 20 toward the second LEDs 29. Similar to the first extending portion 26b1, the second extending portion 26b2 extends to a position that overlaps the second LEDs 29 in a plan view.

As illustrated in FIG. 2, an overall shape of the chassis 22 is landscape rectangular and box-like to cover a substantially overall areas of the light guide plate 20, the LED units 32, and the heat dissipation members 36 from the rear side. The chassis 22 is made of metal, for instance, aluminum-based material. The chassis 22 includes a bottom plate 22a, sidewalls 22b, 22c that upstand from the respective long edges of the bottom plate 22a, and sidewalls that upstand from the respective short edges of the bottom plate 22a. In the chassis 22, space between the LED units 32 is a holding space for the light guide plate 20. A power supply circuit board for supplying power to the LED unit 32 is mounted to the back surface of the bottom plate 22a (not illustrated).

The chassis 22 includes the positioning projections 22t (an example of a positioning portion) on a surface of the bottom plate 22a thereof. The positioning projections 22t are located at portions of the bottom plate 22a where the positioning recesses 20s of the light guide plate 20 overlap in a plan view. Each positioning projection 22t has a block-like shape and protrudes toward the front side. The positioning projection 22t is dimensioned so as to fit into the positioning recess 20s with a slight gap therebetween. The light guide plate 20 is arranged in the chassis 22 with the positioning projections 22t fitted in the positioning recesses 20s. According to the configuration in which the positioning projections 22t are fitted in the positioning recesses 20s, the light guide plate 20 is positioned relative to the chassis 22 and the LEDs 28 and 29 in a plate surface direction (an X-Y plane direction) of the light guide plate 20.

Next, configurations of the first LEDs (an example of a first light source) 28, the second LEDs (an example of a second light source) 29, and the LED board 30 included in the LED unit 32 will be described. The first LEDs 28 are arranged opposite the first light entrance surface 20a1. The second LEDs 29 are arranged opposite the second light entrance surface 20a2. Each of the first and second LEDs 28 and 29 includes an LED chip (not illustrated). The LED chips are mounted on boards that are attached on a surface of the LED board 30 opposite the light guide plate 20. The LED chips are sealed with resin. The LED chip mounted on the board has one main light emission wavelength. Specifically, the LED chip that emits light in a single color of blue is used. The resin that seals the LED chip contains phosphors dispersed therein. The phosphors emit light in a predetermined color when excited by blue light emitted from the LED chip. Thus, overall color of light emitted from the LED 17 is white. The phosphors may be selected, as appropriate, from yellow phosphors that emit yellow light, green phosphors that emit green light, and red phosphors that emit red light. The phosphors may be used in combination of the above phosphors or one single one of the phosphors may be used.

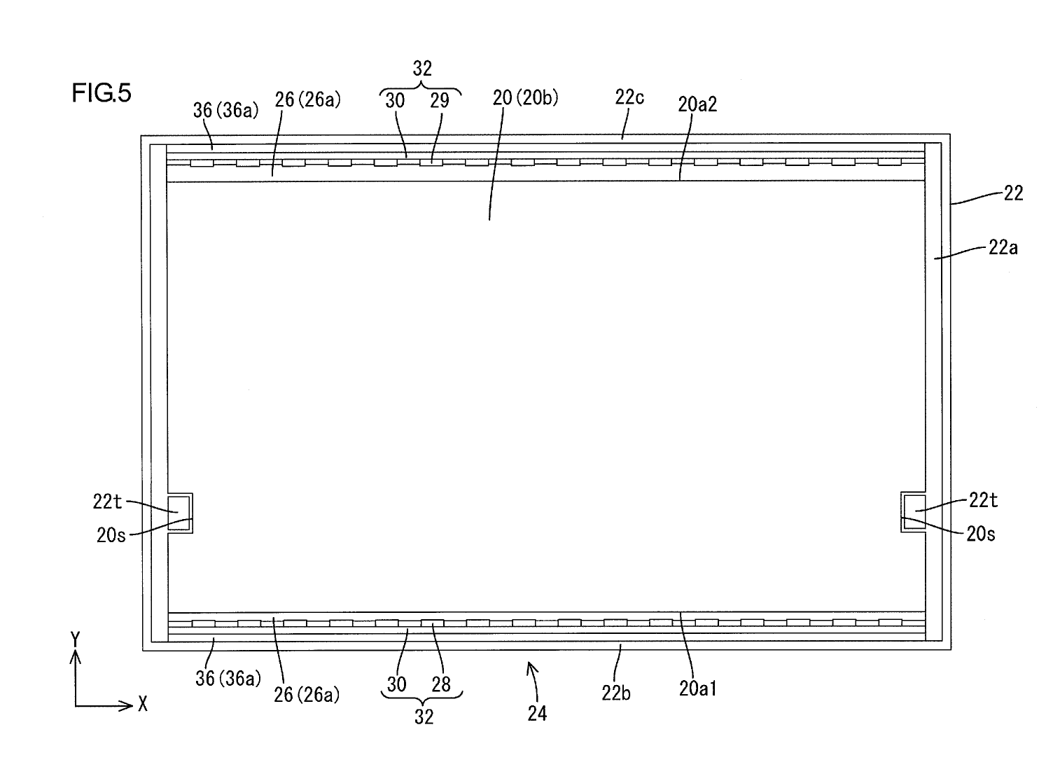

Each LED 28, 29 has a rectangular shape in a front view. The LED 28 includes amain light-emitting surface 28a that is opposite the first light entrance surface 20a1 of the light guide plate 20. The LED 29 includes amain light-emitting surface 29a that is opposite the second light entrance surface 20a2 of the light guide plate 20. Namely, the LED 28, 29 is a so-called top-surface-emitting type LED having a light distribution according to the Lambertian distribution. The LED 28, 29 has a dimension in the Z-axis direction smaller than a thickness of the light guide plate 20. As illustrated in FIGS. 4 and 5, the firsts LED 28 are arranged close to the first light entrance surface 20a of the light guide plate 20. The second LEDs 29 are arranged such that a distance between the second LEDs 29 and the second light entrance surface 20a2 is relatively larger than a distance between the first LEDs 28 and the first light entrance surface 20a1. More specifically, the distance between the second LEDs 29 and the second light entrance surface 20a2 is larger than a maximum distance to which the second light entrance surface 20a2 extends when the light guide plate 20 thermally expands.

The heat dissipation member 36 is made of metal having high thermal conductivity, such as aluminum. As illustrated in FIGS. 4 and 5, the heat dissipation member 36 includes a heat dissipating portion 36a and a mounting portion 36b. The heat dissipating portion 36a and the mounting portion 36b form an angle therebetween so as to have an L-like shape in a cross-section. As illustrated in FIGS. 4 and 5, the mounting portion 36b extends from an outer edge of the heat dissipating portion 36a, which will be described later, in the Z-axis direction toward the front side, that is, toward the frame 14. The mounting portion 36b has a plate-like shape parallel to the light entrance surface 20a1, 20a2 of the light guide plate 20. A long-side direction, a short-side direction, and a thickness direction of the mounting portion are aligned with the X-axis direction, the Z-axis direction, and the Y-axis direction, respectively. The LED board 18 is mounted on an inner surface of the LED attachment portion 19a, that is, a plate surface that faces the light guide plate 16. Specifically, a surface of the LED board 30 opposite from the surface on which the LEDs 28 are mounted faces the mounting portion 36b. While the mounting portion 36b has a long-side dimension that is substantially equal to the long-side dimension of the LED board 30, a short-side dimension of the mounting portion 36b is larger than a short-side dimension of the LED board 30. Therefore, edges of the mounting portion 36b in the short-side direction protrude out from the edges of the mounting portion 36b in the Z-axis direction. Entire outer plate surfaces of the mounting portions 36b, which are plate surfaces opposite from the surfaces on which the LED boards 30 are mounted, are in surface-contact with inner surfaces of the corresponding long-side sidewalls 22b and 22c of the chassis 22.

As illustrated in FIGS. 4 and 5, the heat dissipating portion 36a has a plate-like shape and is parallel to the bottom plate 22a of the chassis 22. A long-side direction, a short-side direction, and a thickness direction of the heat dissipating portion 36a are aligned with the X-axis direction, the Y-axis direction, and the Z-axis direction, respectively. The heat dissipating portion 36a extends inward from a rear edge of the mounting portion 36b (an edge of the mounting portion 36b on the chassis 22 side) in the Y-axis direction. In other words, the heat dissipating portion 36a extends toward an inner portion of the light guide plate 20. An entire rear plate surface of the heat dissipating portion 36a, i.e., a plate surface of the heat dissipating portion 36a facing the chassis 22, is in contact with the plate surface of the bottom plate 22a of the chassis 22. With the plate portions 36a of the heat dissipation members 36 screwed to the bottom plate 22a of the chassis 22, the heat dissipation members 36 are fixed to the chassis 22. With the entire surface of heat dissipating portion 30a is in surface-contact with the plate surface of the chassis 22, heat generated by the LEDs 28, 29 that are turned on is transferred to the chassis 22 via the mounting portion 30b, and the heat dissipating portion 30a. The heat dissipating portions 36a include base portions 36a1, respectively. The base portion 36a1 protrudes from a surface of the heat dissipating portion 36a toward the opposite surface 20c so as to form a trapezoid cross section. The base portion 36a1 extends along the long dimension of the heat dissipating portion 36a. The base portions 36a1 include flat top surfaces. Shock absorbers 40, which will be described later, are disposed on the top surfaces, respectively. Long edge portions of the light guide plate 20 are placed on the top surfaces of the respective base portions 36a1 via the shock absorbers 40 and the reflection sheet 26. With this configuration, the light guide plate 20 is supported by the base portions 36a1.

The shock absorbers 40 is made of urethane, for example. The shock absorber 40 is disposed on the top surface of the base portion 36a1 along the base portion 36a1 of the heat dissipating portion 36a. The shock absorber 40 is arranged at the edge portion of the light guide plate 20 and sandwiched between the reflection sheet 26 and the base portion 36a1 of the heat dissipating portion 36a. Namely, the reflection sheet 26 is arranged away from the heat dissipating portions 36a. With the shock absorbers 40 arranged as described above, even if warping of the reflection sheet 26 occurs, the shock absorbers 40 absorb the warping. Therefore, light reflectivity of the reflection sheet 26 is maintained at a proper level. Further, even if the light guide plate 20 vibrates, the shock absorbers 40 absorb the vibration.

Next, a configuration and a function of the projection 15 of the frame 14 will be described. The projection 15 is a relevant portion of this embodiment. As illustrated in FIG. 4, the frame 14 includes the projection 15 at a portion exposed to the first LEDs 28. The projection 15 projects from the portion farther toward the rear side (toward the opposed surface side). The Projection 15 projects toward the opposed surface 20 farther than the light exit surface 20b. In a cross-sectional view illustrated in FIG. 4, the projection 15 has a rectangular cross section. The projection 15 is closer to the first light entrance surface 20a1 of the light guide plate 20. The projection 15 extends in the X-axis direction along the first light entrance surface 20a1 of the light guide plate 20. The projection 15 projects such that a distal end surface thereof on the rear side is immediately above the first LEDs 28. The distal end surface is a flat surface parallel to the bottom plate 22a of the chassis 22. An inner surface 15a of the projection 15 (an example of an opposed surface), that is, a surface that faces a middle portion of the light guide plate 20 is located closer to the first light entrance surface 20a1 than the main light emitting surfaces 28a of the first LEDs 28. The inner surface 15a is a flat surface parallel to the first light entrance surface 20a1.

A two-dot chain line in FIG. 4 indicates the first light entrance surface 20a1 of the light guide plate 20 that is thermally expanded and extended toward the first LEDs 28. When the first light entrance surface 20a1 moves toward the first LEDs 28, a portion of the first light entrance surface 20a1 contact the inner surface 15a of the projection 15 as illustrated with the two-dot chain line in FIG. 4. The inner surface 15a of the projection 15 is located closer to the first light entrance surface 20a1 than the main light emitting surfaces 28a of the first LEDs 28. Therefore, the first light entrance surface 20a1 contacts the projection 15 before contacting the first LEDs 28. Because the portion of the light entrance surface 20a1 contacts the projection 15, the first light entrance surface 20a1 does not move farther toward the first LEDs 28. Therefore, damages to the first light entrance surface 20a1 due to the contact of the first light entrance surface 20a1 with the first LEDs 28 does not occur. Furthermore, because the first light entrance surface 20a1 does not contact the first LEDs 28 as described above, the first LEDs 28 can be closely arranged to the first light entrance surface 20a1 in this embodiment. This configuration improves the efficiency of incidence to the first light entrance surface 20a1.

As described above, in the backlight unit 24 according to this embodiment, rays of light from the first LEDs 28 enter the light guide plate 20 through the first light entrance surface 20a1 and rays of light from the second LEDs 29 enter the light guide plate 20 through the second light entrance surface 20a2. The rays of light exit the light guide plate 20 through the light exit surface 20b after transmitted through the light guide plate 20. The distance between the first LEDs 28 and the first light entrance surface 20a1 of the light guide plate 20 is relatively small. The distance between the second LEDs 29 and the second light entrance surface 20a2 of the light guide plate 20 is relatively large. The efficiency of incidence from the first LEDs 28 to the first light entrance surface 20a1 of the light guide plate 20 is relatively high. The efficiency of incidence from the second LEDs 29 to the second light entrance surface 20a2 of the light guide plate 20 is relatively low. According to studies of the inventor of this application, a rate of decrease in efficiency of incidence due to an increase in distance between the LEDs 28 or 29 and the light entrance surface 20a1 or 20a2 decreases as the distance becomes equal to or larger than a certain distance and becomes constant. Therefore, the efficiency of incidence from the second LEDs 29 to the second light entrance surface 20a2 becomes lower than the efficiency of incidence from the first LEDs 28 to the first light entrance surface 20a1. However, the efficiency of incidence from the second LEDs 29 to the second light entrance surface 20a2 does not decrease further than a certain level because the rate of decrease in efficiency of incidence due to the increase in distance decreases. When efficiency of incidence under a condition that the distance between the LEDs 28 and the light entrance surface 20a1 and the distance between the LEDs 29 and the light entrance surface 20a2 are set equal is set as a reference, a differential of the efficiency of incidence from the first LEDs 28 to the first light entrance surface 20a1 above the reference is larger than a differential of the efficiency of incidence from the second LEDs 29 to the second light entrance surface 20a2 under the reference. According to the configuration described earlier, overall light use efficiency is improved in comparison to the configuration in which the distance between the LEDs 28 and the light entrance surface 20a1 and the distance between the LEDs 29 and the light entrance surface 20a2 are set equal.

In the backlight unit 24 according to this embodiment, the frame 14 include the projection 15 having the configuration described above. If the first light entrance surface 20a1 of the light guide plate 20 moves toward the first LEDs 28 due to the thermal expansion, the first light entrance surface 20a1 contacts the projection 15 before contacting the first LEDs 28. According to this configuration, the first light entrance surface 20a1 does not mover farther toward the first LEDs 28. Therefore, the first light entrance surface 20a1 does not hit the first LEDs 28, that is, the end surface of the light guide plate 20 does not contact the light source. Therefore, the first LEDs 28 can be arranged closer to the first light entrance surface 20a1. When the configuration that improves the overall light use efficiency is applied to the configuration in which the distance between the LEDs 28 and the light entrance surface 20a1 and the distance between the LEDs 29 and the light entrance surface 20a2 are equal as described above, the efficiency of using light from the first LEDs 28 is significantly increasable. According to the backlight unit 24 of this embodiment, the light use efficiency is significantly increasable by keeping the end surface of the light guide plate 20 from the first LEDs 28 when the light guide plate 20 is thermally expanded.

In this embodiment, the side surfaces of the first LEDs 28 closer to the light exit surface 20b are located closer to the opposite surface 20c than a distal end of the projection 15 on the opposite surface 20c side. Namely, the distal end surface 15b of the projection 15 on the rear side is located immediately above the first LEDs 28. Because the side surfaces of the first LEDs 28 closer to the light exit surface 20b are located closer to the opposite surface 20c than a distal end of the projection 15 on the opposite surface 20c side, a portion of the projection 15 is located between the main light emitting surfaces 28a of the first LEDs 28 and the first light entrance surface 20a1. According to this configuration, some rays of light from the first LEDs 28 are blocked by the projection 15 and thus the efficiency of incidence decreases. According to the configuration of this embodiment, the rays of light from the first LEDs 28 are not blocked by the portion of the projection 15. Therefore, the efficiency of incidence according to the light that enters the first light entrance surface 20a1 is maintained at a preferable level.

According to this embodiment, the inner surface 15a of the projection 15 is parallel to the first light entrance surface 20a1 of the light guide plate 20. Namely, the inner surface 15a is the opposed surface that is in surface contact with the first light entrance surface 20a1 during the thermal expansion of the light guide plate 20. With the surface contact of the first light entrance surface 10a1 of the light guide plate 20 with the projection 15, the extension of the light guide plate 20 is restricted during the thermal expansion of the light guide plate 20. The expansion of the light guide plate 20 is effectively restricted.

In this embodiment, the distance between each second LED 29 and the second light entrance surface 20a is larger than the maximum distance for which the second light entrance surface 20a moves during the thermal expansion of the light guide plate 20. With this configuration, the second light entrance surface 20a2 is less likely to contact the second LEDs 29 during the thermal expansion of the light guide plate 20.

In this embodiment, the positioning recesses 20s and the positioning projections 22t are provided to orient the light guide plate 20 in the direction perpendicular to the first light entrance surface 20a1 (in the Y-axis direction) with respect to the LEDs 28 and 29. Furthermore, the positioning recesses 20s and the positioning projections 22t are arranged such that the distance between each LED 29 and the second light entrance surface 20a2 is larger than the distance between each LED 28 and the first light entrance surface 20a1. According to this configuration, the light guide plate 20 extends with the positioning recesses 20a as base points of the extension due to the thermal expansion of the light guide plate 20. Variations in positions of the light entrance surfaces 20a1 and 20a2 of the light guide plate 20 due to the extension thereof tend to be proportional to the distance between the positioning recess 20s and the light entrance surface 20a1 and the distance between the positioning recess 20s and the light entrance surface 20a2, respectively. By setting the distance between the positioning recess 20s and the second light entrance surface 20a2 of the light guide plate 20 larger than the distance between the positioning recess 20s and the first light entrance surface 20a1 of the light guide plate 20, the variation in position of the second light entrance surface 20a2 due to the thermal expansion of the light guide plate 20 is larger than the variation in position of the first light entrance surface 20a1. With the distance between each second LED 29 and the second light entrance surface 20a2, which is relatively large, the extension of the light guide plate 20 is allowed. According to this configuration, a sum of the distance between the LED 28 and the light entrance surface 20a1 and the distance between the LED 29 and the light entrance surface 20a2 can be reduced as much as possible. Therefore, the size of the backlight unit 24 (or the frame) can be reduced.

This embodiment includes the reflection sheet 26 having light reflectivity and arranged on the opposite surface 20c of the light guide plate 20. The reflection sheet 26 includes the extending portion 26b1 at the edge thereof on the first light entrance surface 20a1 side and the extending portion 26b2 at the edge thereof on the second light entrance surface 20a2 side. The extending portion 26b1 extends farther toward the first LEDs 28 than the first light entrance surface 20a1. The second the extending portion 26b2 extends farther toward the second LEDs 29 than the second light entrance surface 20a2. According to this embodiment, the rays of light traveling from the first LEDs 28 toward the opposite surface 20c are reflected by the first extending portion 26b1 toward the first light entrance surface 20a1. Furthermore, the rays of light traveling from the second LEDs 29 toward the opposite surface 20c are reflected by the second extending portion 26b2 toward the second light entrance surface 20a2. With this configuration, the efficiency of incidence to the first light entrance surface 20a1 and the efficiency of incidence to the second light entrance surface 20a2 are further improved.

When the television device TV is set in the vertical position, the gravity of the light guide plate 20 acts downward in an elevation view (a view when FIG. 5 is viewed from the front), that is, toward the first LEDs 28. If nothing to restrict the first light entrance surface 20a1 to move toward the first LEDs 28 is provided, forces may be applied to the first LEDs 28 because of the weight of the light guide plate 20 even a moving distance of the first light entrance surface 20a1 is smaller than the distance between the first light entrance surface 20a1 and each first LED 28. According to this embodiment, the contact of the first light entrance surface 20a1 with the first LEDs 28 is restricted by the projection 15. Therefore, even when the television device TV is set in the vertical position, forces caused by the weight of the light guide plate 20 are less likely to be applied to the first LEDs 28.

### Second Embodiment

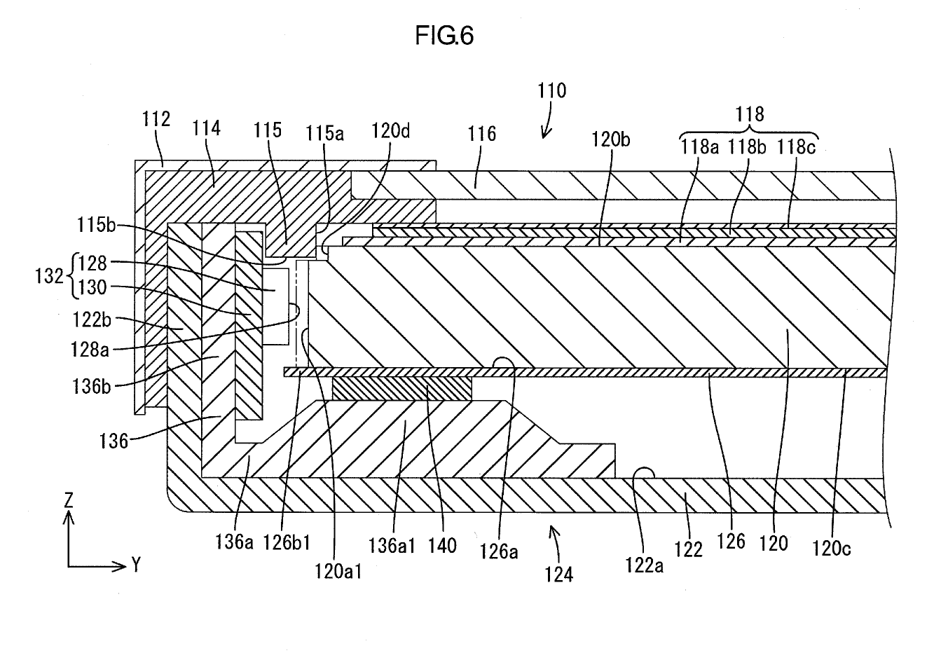

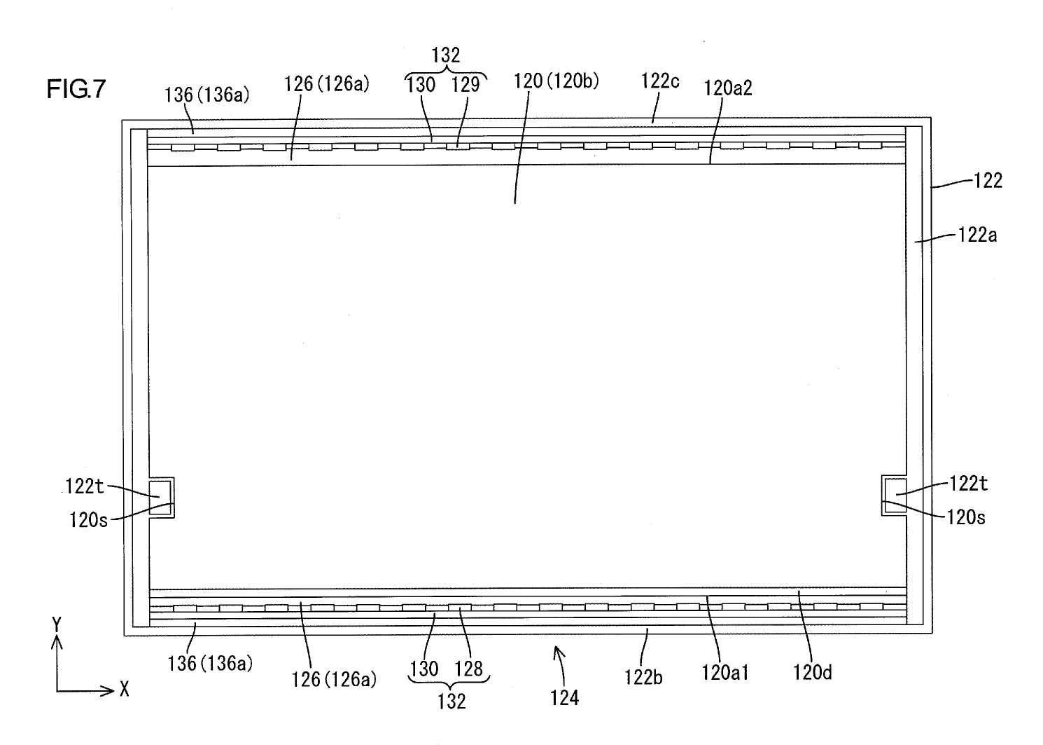

A second embodiment will be described with reference to the drawings. The second embodiment includes a light guide plate that includes a recess in a portion close to a first light entrance surface thereof, which is a configuration different from the first embodiment. Other configurations are the same as the first embodiment and thus configurations, functions, and effects of those will not be described. In FIGS. 6 and 7, portions indicated by numerals including the reference numerals in FIGS. 4 and 5 with 100 added thereto have the same configurations as the portions indicated by the respective reference numerals in the first embodiment.

As illustrated in FIG. 6, a backlight unit 124 according to the second embodiment includes a light guide plate 120 having a recess 120d at an edge defined by a light exit surface 120b and a first light entrance surface 120a1. The recess 120d is open on a light exit surface 120b side and a first light entrance surface 120a1 side. The recess 120d is defined by a sidewall that faces first LEDs 128 and is parallel to a first light entrance surface 120a1 and a bottom wall that is parallel to the light exit surface 120b. In the cross-sectional view, the recess 120d forms a step down toward the rear side. The sidewall that defines the recess 120d is parallel to an inner surface 115a of a projection 115 of a frame 114. A distance between the sidewall of the recess 120d and the inner surface 115a of the projection 115 is smaller than a distance between each first LED 128 and the first light entrance surface 120a1. The projection 115 is formed and arranged such that a distal end surface 115b on the rear side is slightly away from the bottom wall that defines the recess 120d and within the recess 120d. As illustrated in FIG. 7, the recess 120d continuously extends along the edge of the light exit surface 120b on the first light entrance surface 120a1 side. Because the recess 120d continuously extends along the edge of the light exit surface 120b, the light exit surface 120b contacts the projection 115 for an entire length thereof during the thermal expansion of the light guide plate 120. With this configuration, the contact of the first light entrance surface 120a with the first LEDs 128 are effectively restricted.

A width of the projection 115 measuring in a direction perpendicular to the first light entrance surface 120a (a dimension measuring in the Y-axis direction) needs to be larger than a certain size (e.g., 1 mm or larger) to maintain the strength thereof. If the distance between each first LED 128 and the first light entrance surface 120a1 is very small, the width of the projection 115 needs to be small. As a result, the strength of the projection 115 is not maintained. Because of the recess 120d in the light guide plate 120 of this embodiment, the portion of the projection 115 is arranged closer to the middle portion of the light guide plate 120 than the first light entrance surface 120a1 of the light guide plate 120. Therefore, the width of the projection 115 is larger (e.g., 1 mm or larger) than the distance between the first LED 128 and the light guide plate 120. Namely, the width of the projection 115 is larger than that of the first embodiment. In this embodiment, during the thermal expansion of the light guide plate 120, the first light entrance surface 120a1 moves toward the first LEDs 128 and sidewall of the recess 120d moves toward the first LEDs 128 (as indicated by the two-dot chain line in FIG. 6). Because the projection 115 and the recess 120d of this embodiment are in such forms and in such an arrangement as described above, the sidewall of the recess 120d contacts the inner surface 115a of the projection 115 before the first light entrance surface 120a1 contacts the first LEDs 128 during the thermal expansion of the light guide plate 120. With this configuration, the end surface of the light guide plate 120 does not contact the first LEDs 128. According to this embodiment, the distance between each LED 128 and the first light entrance surface 120a1 can be reduced while the strength of the projection 115 is maintained.

### Modification of Second Embodiment

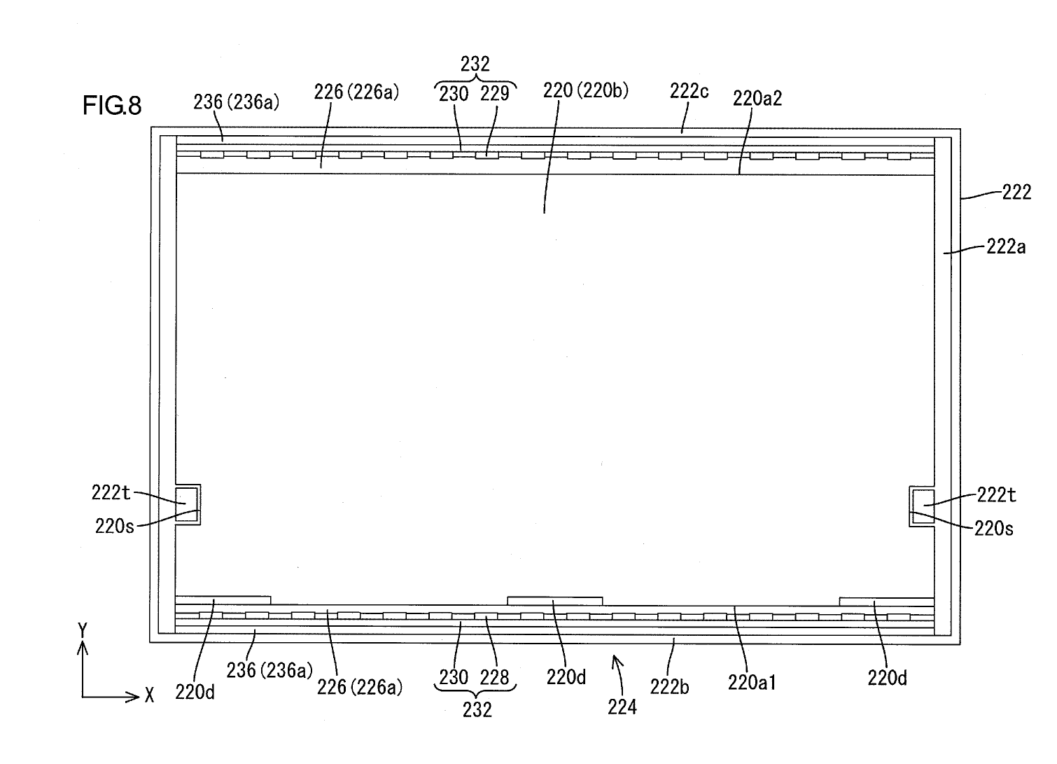

A modification of the second embodiment will be described. In FIG. 8, portions indicated by numerals including the reference numerals in FIG. 7 with 100 added thereto have the same configurations as the portions indicated by the respective reference numerals in the second embodiment. As illustrated in FIG. 8, the modification includes recesses 220d arranged differently from the second embodiment. Specifically, the recesses 220d are arranged along an edge of a light exit surface 220b on a first light entrance surface 220a1 side such that the recesses 220d are separated from each other (i.e., discontinuously arranged). Projections project from portions of a frame corresponding to the recesses 220d (not illustrated). Even though the recesses 220d and the projections are provided only in some portions, the projections are placed in the recesses 220d during expansion of the light guide plate 220. With this configuration, further expansion of the light guide plate 220 does not occur and the first light entrance surface 220a1 does not contact first LEDs 228.

### Third Embodiment

A third embodiment will be described with reference to the drawings. The third embodiment includes first LEDs 328, a vertical dimension and an arrangement of which are different from the second embodiment and a projection 315, a width of which is different from the second embodiment. Other configurations are the same as the first and the second embodiments and thus configurations, functions, and effects of those will not be described. In FIG. 9, portions indicated by numerals including the reference numerals in FIG. 4 with 300 added thereto have the same configurations as the portions indicated by the respective reference numerals in the first embodiment and the second embodiment.

The backlight unit 324 according to the third embodiment includes a recess 320d formed at an edge defined by a light exit surface 320b and a first light entrance surface 320a1 similar to the second embodiment. A form and a configuration of the recess 320d are similar to the second embodiment. In FIG. 9, a vertical dimension of each first LED 328 (a dimension measuring in the Z-axis direction) is larger than those of the first embodiment and the second embodiment. Specifically, a side surface of each first LED 328 on the front side is at the same Z-axis position as a bottom wall of the recess 320d and closer to an opposed surface 320c than a distal end surface 315b of the projection 315 on the rear side. A side surface of each first LED 328 on the rear side is closer to a bottom plate 322a of the chassis 322 than the opposed surface 320c of the light guide plate 320.

If the side surface of the first LED 328 on the light exit surface 320b side is closer to the light exit surface 320b than a distal end of the projection 315 on the opposed surface 320c side, a portion of the projection 315 is located between a main light emitting surfaces 328a of the first LEDs 328 and a first light entrance surface 320a1. In this case, some rays of light emitted by the first LEDs 328 are blocked by the projection 315 and efficiency of incidence to the first light entrance surface 320a1 decreases. In this embodiment, the length of each first LED 328 is larger than that of the first embodiment and that of the second embodiment. With this configuration, the rays of light are not blocked by the projection 315 although the efficiency of incidence to the first light entrance surface 320a1 are increased. Therefore, a proper level of the efficiency of light to the first light entrance surface 320a1 is achieved.

### Fourth Embodiment

A fourth embodiment will be described with reference to the drawings. The fourth embodiment includes a recess, a form and an arrangement of which are different from the second embodiment and the third embodiment. Other configurations are the same as the first and the third embodiments and thus configurations, functions, and effects of those will not be described. In FIG. 10, portions indicated by numerals including the reference numerals in FIG. 4 with 400 added thereto have the same configurations as the portions indicated by the respective reference numerals in the first embodiment.

As illustrated in FIG. 10, a backlight unit 424 according to the fourth embodiment includes a recess 420d that is open only on a light exit surface 420b side. Namely, the recess 420d is in a form of a groove in the light exit surface 420b close to an edge on a first light entrance surface 420a1 side. The recess 420d extends along the edge. A distal end of a projection 415 is held in the recess 420c that has a form of a groove. Even though the recess 420d is in such a form and such an arrangement, a sidewall of the recess 420d is adjacent to a first light entrance surface 420a1. During thermal expansion of the light guide plate 420, a sidewall that faces toward first LEDs 428 of the recess 420d moves toward the first LEDs 428 (as indicated by a two-dot chain line in FIG. 10) as the first light entrance surface 420a1 moves toward the first LEDs 428. In this embodiment, a distance between the sidewall of the recess 420d facing toward the first LEDs 428 and an inner surface 415a of the projection 415 is smaller than a distance between each first LED 428 and the first light entrance surface 420a1. During the thermal expansion of the light guide plate 420, the sidewall of the recess 420 contacts the inner surface 415a of the projection 415 before the first light entrance surface 420a1 contacts the first LEDs 428. With this configuration, an end surface of the light guide plate 420 does not contact the first LEDs 428. With the configuration including the recess 420d that is in the form of a groove, the end surface of the light guide plate 420 does not contact the first LEDs 428.

In the configuration of this embodiment, the projection 415 is not arranged immediately above the first LEDs 428. Rays of light emitted by the first LEDs 428 enter the first light entrance surface 420a1 throughout an entire area of the first light entrance surface 420a1. With this configuration, efficiency of incidence is improved. In the configuration of this embodiment, the projection 415 of the frame 414 is held in the recess 420d that is in the form of a groove. According to this configuration, the light guide plate 420 is further properly positioned with respect to the Y-axis direction.

Modifications of the above embodiments will be listed below.

(1) In each of the above embodiments, the inner surface of the projection is a flat surface parallel to the first light entrance surface and the distal end surface of the projection is a flat surface parallel to the light exit surface. However, the shape of the projection is not limited to the above configuration. The projection may have any shape or configuration as long as a portion of the first light entrance surface or a portion of the recess contacts a portion of the projection before the first light entrance surface contacts the first LEDs.

(2) In each of the above embodiments, a portion of the first light entrance surface or a portion of the recess is brought into a surface contact with a portion of the projection during the thermal expansion of the light guide plate. The configuration is not limited to such a configuration that causes the surface contact. The first light entrance surface, the recess, and the projection may have any configurations as long as the movement of the first light entrance surface is restricted with a portion of the first light entrance surface or a portion of the recess contacting a portion of the projection.

(3) In each of the above embodiments, the heat dissipation member includes the base portion. However, the heat dissipation member may not include the base portion. Furthermore, the heat dissipation member is not required.

(4) In each of the above embodiments, the reflection sheet is separated from the heat dissipating portions of the heat dissipation members with the shock absorbers. However, the shock absorbers are not required.

(5) The configuration, the shape, and the arrangement of the projection in each of the above embodiments may be altered as appropriate.

(6) The configuration, the shape, and the arrangement of the recess in each of the embodiments 2 through 4 may be altered as appropriate.

(7) In each of the above embodiments, the liquid crystal display device including the liquid crystal panel as the display panel is used. However, the aspect of the present invention can be applied to display devices including other types of display panels.

(8) In each of the above embodiments, the television device including the tuner is used. However, the present invention can be applied to display devices without tuners.

The embodiments have been described in detail. However, the above embodiments are only some examples and do not limit the scope of the claimed invention. The technical scope of the claimed invention includes various modifications of the above embodiments.

The technical elements described in this specification and the drawings may be used independently or in combination to achieve the technical benefits. The combinations are not limited to those in original claims. With the technologies described in this specification and the drawings, multiple objects may be accomplished at the same time. However, the technical benefits can be achieved by accomplishing even only one of the objects.

### EXPLANATION OF SYMBOLS

TV: Television device, Ca, Cb: Cabinet, T: Tuner, S: Stand, 10, 110, 310, 410: Liquid crystal display device, 12, 112, 312, 412: Bezel, 14, 114, 314, 414: Frame, 15, 115, 315, 415: Projection, 16, 116, 316, 416: Liquid crystal panel, 18, 118, 218, 318: Optical member, 20, 120, 220, 320, 420: Light guide plate, 20a, 120a, 220a, 420a: Light entrance surface, 20a1, 120a1, 220a1, 320a1, 420a1: First light entrance surface, 20a2, 120a2, 220a2, 320a2, 420a2: Second light entrance surface, 20b, 120b, 220b, 320b, 420b: Light exit surface, 20c, 120c, 320c, 420c: Opposed surface, 22, 122, 222, 322, 422: Chassis, 324, 424: Backlight unit, 26, 126, 226, 326, 426: Reflection sheet, 28, 128, 228, 328, 428: First LED, 29, 129, 229, 329, 429: Second LED, 30, 130, 230, 330, 430: LED board, 32, 132, 232, 332, 432: LED unit, 36, 136, 236, 336, 436: heat dissipation member, 40, 140, 340, 440: shock absorber.

1. A lighting device comprising:
a light guide plate including two end surfaces and plate surfaces, the end surfaces being configured as light entrance surfaces, one of the plate surfaces being configured as a light exit surface, another one of the plate surfaces being configured as an opposite surface;
a first light source including a main light emitting surface arranged opposite the first end surface of the light guide plate configured as the first light entrance surface;
a second light source including a main light emitting surface arranged opposite the second end surface of the light guide plate opposite from the first end surface and configured as the second light entrance surface, second light source being arranged such that a distance between the second light source and the second light entrance surface is larger than a distance between the first light source and the first light entrance surface; and
a frame-shaped member having a frame-like shape and arranged over a side surface of the first light source closer to the light emit surface and an edge portion of the light exit surface so as to cover the first light source and the edge portion of the light exit surface, the frame-shaped member including a projection projecting from a portion of the frame-shaped member exposed to the first light source farther toward the opposed surface than the light exit surface and including a portion arranged closer to the first light entrance surface than the main light emitting surface of the first light source.

2. The lighting device according to claim 1, wherein
the light guide plate includes a recess that is open at least on a light exit surface side,
at least a portion of the projection is arranged in the recess, and
a distance between the projection and a wall of the recess facing toward the first light source is smaller than a distance between the first light source and the first light entrance surface.

3. The lighting device according to claim 2, wherein the recess is formed at an edge of the light exit surface and open on a first light entrance surface side.

4. The lighting device according to claim 3, wherein the recess continuously extends along the edge of the light exit surface.

5. The lighting device according to claim 3, wherein the projection has a width measuring in a direction perpendicular to the first light entrance surface is larger than the distance between the first light source and the first light entrance surface.

6. The lighting device according to claim 1, wherein the side surface of the first light source closer to the light exit surface is arranged closer to the opposite surface than a distal end of the projection on an opposite surface side.

7. The lighting device according to claim 1, wherein the projection includes an opposed surface that is in surface contact with the first light entrance surface during thermal expansion of the light guide plate.

8. The lighting device according to claim 1, wherein a distance between the second light source and the second light entrance surface is larger than a maximum distance for which the second light entrance surface moves during thermal expansion of the light guide plate.

9. The lighting device according to claim 1, further comprising a positioning portion for positioning the light guide plate relative to the first light source and the second light source with respect to a direction perpendicular to the first light entrance surface such that a distance between the second light source and the second light entrance surface is larger than a distance between the first light source and the first light entrance surface.

10. The lighting device according to claim 1, further comprising a reflection sheet having light reflectivity and arranged on the opposite surface of the light guide plate, the reflection sheet extending such that an edge of the reflection sheet on a first light entrance surface side is closer to the first light source than the first light entrance surface and an edge of the reflection sheet on a second light entrance surface side is closer to the second light source than the second light entrance surface.

11. A display device comprising:
a display panel displaying an image using light from the lighting device according to claim 1.

12. The display device according to claim 11, wherein the display panel is a liquid crystal panel including liquid crystals.

13. A television device comprising the display device according to claim 11.
